(19) United States
(12) Patent Application Publication
(10) Pub. No.: US 2003/0044712 A1
(43) Pub. Date: Mar. 6, 2003

(54) Carrier for electrophotography

(76) Inventors: Kenshi Matsui, Osaka (JP); Yukihiro Mori, Osaka (JP); Hiroshi Yamada, Osaka (JP)

Correspondence Address: SHINJYU GLOBAL IP COUNSELORS, LLP, 1233 20TH STREET, NW, SUITE 700, WASHINGTON, DC, 20036-2680, US

(21) Appl. No.: 09/944,586

(22) Filed: Sep. 4, 2001

(51) Int. Cl. G03G 9/113

(52) U.S. Cl. 430/111.32; 430/111.35

(57) ABSTRACT

A carrier for use in electrophotography provided by the present invention satisfies such conditions that when (i) the porosity of the surface of a core particle is A %(A≦40) and (ii) the resin-coated rate of the porous part of the surface the core particle is B %, (iii) A×B/100 is 15 or more and further (ix) the resin-coated rate of the smooth part, besides the porous part, is 20% or less.

### BACKGROUND OF THE INVENTION

1. Field of the Invention

The present invention relates to carriers for use in electrophotography. More specifically, the present invention relates to carriers having long-lasting reliable developing properties and a long-lasting capability to form stable high quality images.

2. Background Information

In conventional electrophotography, magnetic brush development techniques have widely been used as a method of developing electrostatic latent images. The use of a two-component developer having a carrier and toner is common for this purpose.

Extending the life of image forming devices has been desired. In order to achieve this goal, expanding the life of two-component developers is a factor. Thus, improvement of carrier durability is indispensable. A variety of measures have been taken to prevent the accumulation of toner on the surfaces of carrier particles and the peeling of resin coatings, which are common carrier problems. To prevent a resin coating from peeling, for example, the amount of coating resin used was increased and a hard resin coating was employed. However, these methods have yet to exhibit sufficient results. The peeling of a resin coating seriously affects carrier properties, such as resistivity and charge distribution properties, as well as image properties. As mentioned, carrier life has yet to be sufficiently extended.

In view of the above, there exists a need for a carrier which overcomes the above mentioned problems in the prior art. This invention addresses this need in the prior art as well as other needs, which will become apparent to those skilled in the art from this disclosure.

### SUMMARY OF THE INVENTION

An object of the present invention is to control peeling of a resin coating and to improve durability of a carrier.

To solve the aforementioned problems, the present invention provides a specific feature to core particles and a resin coating applied to the surface of the core particles of a carrier for use in electrophotography that satisfies the following conditions:

(i) when the porosity of the surface of a core particle is represented by A %, A≦40, and

(ii) the resin-coated rate of the porous part of the surface the core particle B %; then

(iii) A×B/100 is 15 or more; and

(iv) the resin-coated rate of the smooth part, besides the porous part, is 20% or less.

After strenuous study, we found that a resin coating that has adhered fly to the porous part on the surface of a core particle peels with difficulty while a resin coating on the smooth part peels easily. This implies that toner and carrier particles contact each other more often on the smooth part than on the porous part resulting in easy peeling of the coating from the smooth part. Therefore, we designed a developer such that a carrier particle has a porous part on its surface that is larger than a specific level. Further, the ratio of the resin-coated rate of the porous part against the resin-coated rate of the whole surface is maintained over the defined level while controlling the resin-coated rate of the smooth part. This developer has significantly reduced the difference between the amount of resin coating present before and after running, thus, providing high durability. In addition, this type of developer also reduced fluctuations in the image properties. However, a higher porous part rate allows easy peeling of the resin coating from the porous part because the porous part becomes similar to the smooth part and contacts more often with toner particles.

As mentioned above, although a resin coating on the porous part hardly peels while on the smooth part, the resin coating peels easily on the porous part if the following conditions are not satisfied:

(i) the porosity of the surface of a core particle is represented by A % (A≦40);

(ii) the resin-coated rate of the porous part of the surface the core particle is represented by B %;

(iii) A×B/100 is 15 or more, and

(iv) the resin-coated rate of the smooth part, besides the porous part, is 20% or less.

If the conditions are met, the resin-coated rate after 30,000 prints can be maintained at a level that is almost the same as that at an initial running. Consequently, carrier properties are firmly preserved and the use of this type of developer enables images to be produced with properties similar to those at an initial running.

When the value of the aforementioned A×B/100 falls less to than 15, the absolute amount of coating resin becomes insufficient to impart a charge to the toner. However, the quantity of the electric charge does not always increase in proportion to the increase in the absolute amount of coating resin. When the value of A×B/100 exceeds 15, the quantity of the electric charge fluctuates little. However, even if the value of A×B/100 is higher than 15, if A, the porosity of the surface of a core particle, exceeds 40%, core particles fluidity deteriorates. Poor fluidity causes uneven mixing of the toner, which results in generating uncharged toner particles and causing image fogging and other problems. Moreover, when porosity A exceeds 40%, the porous part may become similar to the smooth part. Further, when the resin-coated rate of the smooth part exceeds 20%, the resin coating tends to peel resulting in fluctuation of carrier properties and consequent deterioration of image properties. The resin-coated rate of the smooth part is desirably as low as possible and optimally 0%. However, it is difficult to coat resin just on the porous part of the carrier, and approaching a 0% resin-coated rate have been proven difficult. Nevertheless, the present invention provides sufficient effects by limiting the resin-coated rate of the smooth part to less than 20%.

Especially, when inorganic particles, for example, titanium oxide, are used as a surface treatment agent for toner, the resin coating is scraped in a conventional carrier as printing continues. The scraping is accompanied by fluctuations in carrier properties and a deterioration of image properties. The carrier of the present invention sharply reduces peeling of the resin coating and achieves high durability.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a view of a table depicting the results of particles with various porosities and resin coating rates in accordance with an embodiment of the present invention;

FIG. 2 is a view of a table depicting the results comparing particles with various porosities and resin coating rates not in accordance with an embodiment of the present invention; and

FIG. 3 is a view of a table depicting the results comparing particles with various porosities and resin coating rates not in accordance with an embodiment of the present invention.

### DETAILED DESCRIPTION OF THE PREFERRED EMBODIMENTS CORE PARTICLE

The core particle of the present invention uses well-known magnetic materials such as sintered ferrite, magnetite, lithium, manganese and iron powder.

A method of manufacturing a ferrite carrier is as follows.

A material is first temporarily sintered. The material is then immersed in water and finely crushed using, for example, a ball mill. The material is mixed with polyvinyl alcohol as a binder and added with an anti-forming agent, dispersant, and others, to prepare a slurry for granulation. Binders and dispersants are selected from such materials that will dissolve or be consumed in the sintering process and preferably not exert adverse effects during the sintering ferrite forming processes.

The slurry is then heated and dried with a spray drier to be converted into particles. The dried particle is round and generally called a granule. The granules are filled in an aluminum container and sintered. A tunnel furnace is commonly used to sinter ferrite. The sintering temperature is held between about 900 C° and about 1400 C°, and the sintering time is from 10 hrs. to 30 hrs. The granules are cooled after sintering, occasionally cooled in an N2 environment to control electric resistance as carrier.

In this sintering process, solid state chemical reactions are occurred creating ferrite. For example, porosity of the surface of a core particle can be adjusted by changing the sintering temperature above. The higher the temperature is, the smoother the surface is and the lower the temperature is, the rougher the surface or the higher the porosity is. In this case, the fact that both smooth and porous parts exist at the same time on the surface of a core particle means, namely, the smooth part occupies 50% or more of the area. In other words, if the porous part occupies 50% or more of the area, the porous part is estimated as the smooth part and the smooth part as projections.

The diameter of a core particle is generally in the range of 20 μm to 200 μm, preferably in the range of 30 μm to 150 μm, which is determined by well-known laser diffraction techniques.

As magnetic powder for use in preparing this core particle, any well-known magnetic powder can be used, for example, ferromagnetic iron oxides such as triiron tetraoxide (Fe₃O₄) and iron sesquioxide (gamma-Fe₂O₃); ferrites such as zinc iron oxide (ZnFe₂O₄), yttrium iron oxide (Y₃Fe₅O₁₂), cadmium iron oxide (CdFe₂O₄), gadolinium iron oxide (Gd₃Fe₅O₁₂), copper iron oxide (CuFe₂O₄), lead iron oxide (PbFe₁₂O₁₉), neodymium iron oxide (NdFeO₃), barium iron oxide (BaFe₁₂O₁₉), manganese iron oxide (MnFe₂O₄), lanthanum iron oxide (LaFeO₃) and composites thereof; ferromagnetic metals such as iron powder (Fe), cobalt powder (Co), nickel powder (Ni), and alloys thereof. These powders can be used solely or combinatory. The shape of a magnetic material is not limited in particular and can be spherical, cubic, or irregular.

Resin Coating

Resin used to coat a core particle in the present invention can be, for example, (meth)acryl resins; styrene resins; styrene-(meth)acryl resins; olefin resins such as polyethylene, chlorinated polyethylene, polypropylene, etc.; polyester resins such as polyethylene terephthalate, polycarbonate, etc.; unsaturated polyester resins; vinyl chloride resins; polyamide resins; polyurethane resins; epoxy resins; silicon resins; fluorine resins such as poly(tetrafluoroethylene), polychlorotrifluoroethylene, poly vinylidene fluoride, etc.; phenol resins; xylene resins; and diallyl phthalate resins. The resins described above can be used solely or in the form of a mixture thereof.

In addition, to a resin coating, small amounts of additives such as silica, alumina, carbon black, metal salts of fatty acids, can be added to improve properties of the resin coating if the need arises.

As the method to coat resin over a core particle, methods such as mechanical mixing, spraying, submersing, fluidized bed granulation, and rolling granulation methods, can be employed.

As a solvent for resin coating, the following compounds can be used, for example, aromatic hydrocarbons such as toluene and xylene; halogenated hydrocarbons such as trichloroethylene and perchloroethylene; ketones such as acetone and methyl ethyl ketone; cyclic ethers such as tetrahydrofuran; and alcohols such as methanol, ethanol, and isopropanol.

### EXAMPLES

The invention will now be further illustrated by way of the following examples and comparative examples.

### Example 1

For 100 wt. % of a core material having spherical ferrite particles (median particle diameter being 60.3 μm) with the porosity of 39.8%, 0.5 wt. % of poly(tetrafluoroethylene) resin was dispersed in tetrahydrofuran to prepare a resin or coating solution. The core material described above was coated with this resin solution by the steps of; (1) applying spray coating with this resin solution using a fluidized bed coating system, (2) applying heat treatment for about 30 min. at 300 C° in the fluidized bed, (3) mixing the resultant heat-treated core material together with iron particles using an orbiting-screw mixer sold under the name Nauta Mixer(R)™, and (4) preparing a carrier in which the resin-coated rate of the porous part of the core material was 96.8% and that of the smooth part of the core material was 2.8%. To 100 wt. % of the resultant carrier, 5 wt. % of a commercially available black toner (positive toner) was added and mixed in a 3 liter container on a ball mill resulting in preparing the developer of Example 1.

### Examples 2-6, Comparative Examples 1-6, 13-18

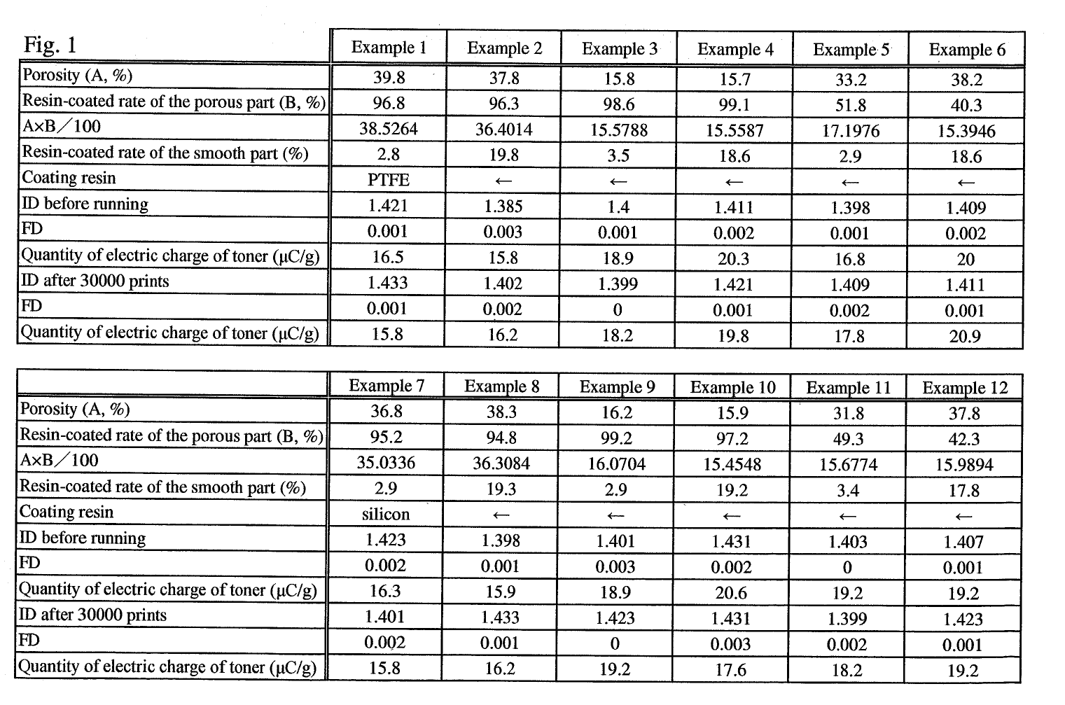

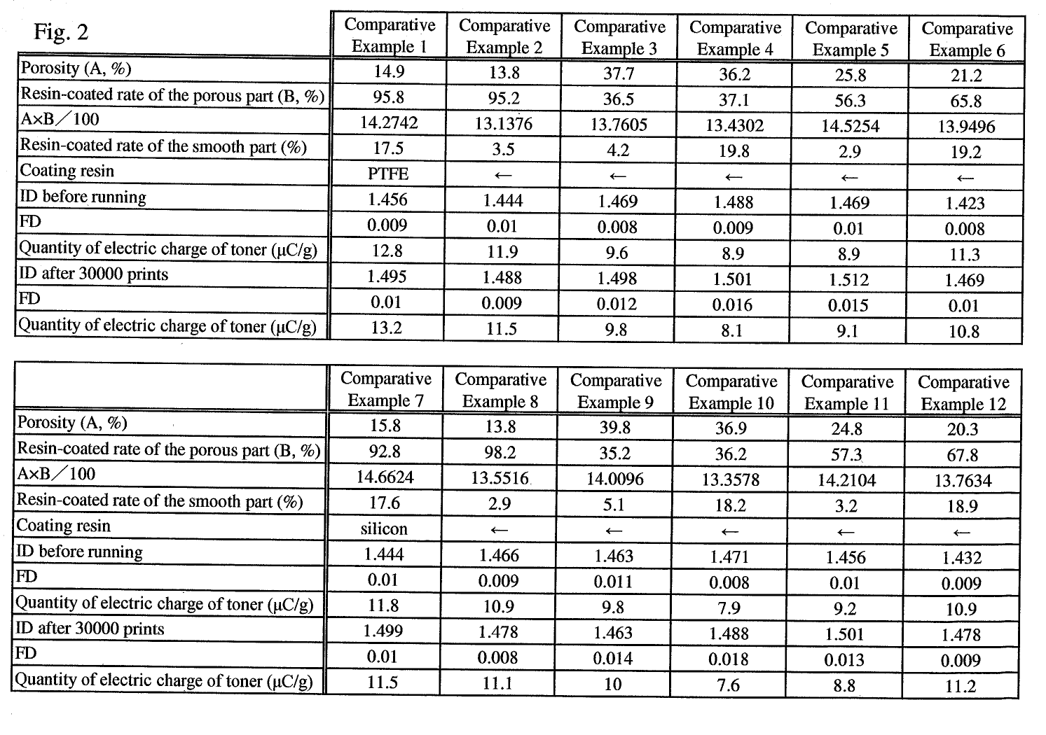

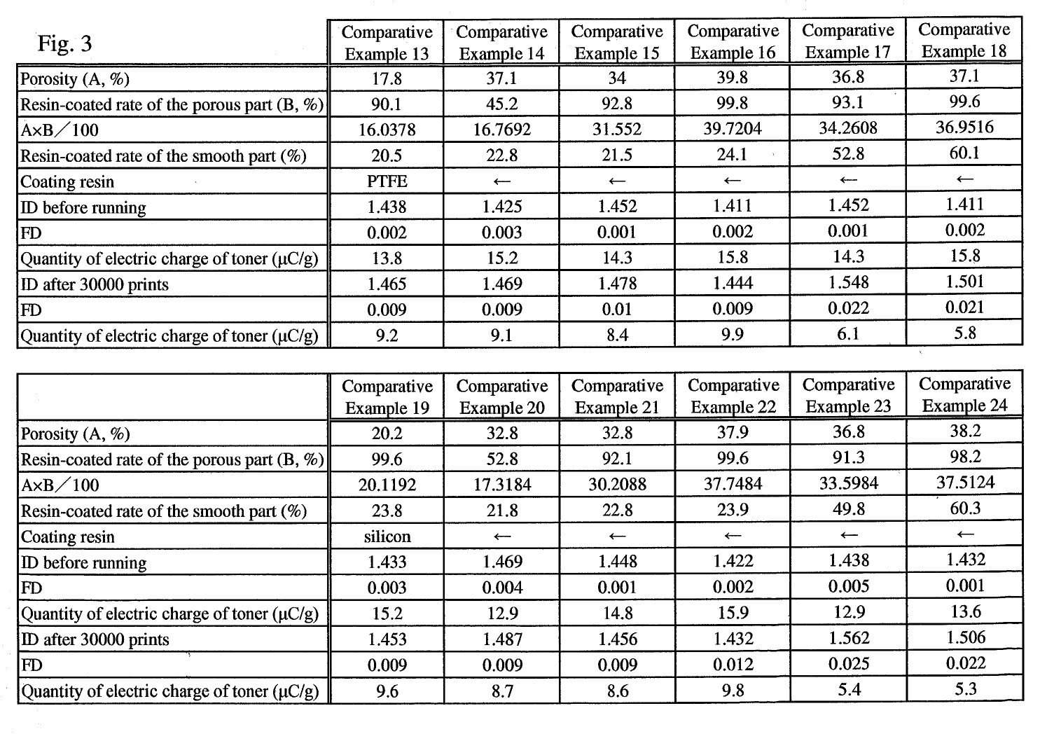

For these examples, developers were prepared in the same manner as Example 1. However, the developer porosities of spherical ferrite particles and coating rates of carriers were changed as recorded in the FIGS. 1, 2, and 3.

### Example 7

For 100 wt. % of a core material having spherical ferrite particles (median particle diameter being 60.3 μm) with the porosity of 36.8%, 0.5 wt. % of silicon resin was dispersed in toluene to prepare a resin or coating solution. The core material described above was coated with this resin solution by the steps of, (1) applying spray coating with this resin solution using a fluidized bed coating system, (2) applying heat treatment for about 30 min. at 300 C° in a fluidized bed, (3) mixing the resultant heat-treated core material together with iron particles using an orbiting-screw mixer sold under the name Nauta Mixer(R)™, and (4) preparing a carrier in which the resin-coated rate of the porous part of the core material was 95.2% and that of the smooth part of the core material was 2.9%. To 100 wt. % of the resultant carrier, 5 wt. % of a commercially available black toner (positive toner) was added and mixed in a 3 liter container on a ball mill resulting in preparing the developer of Example 7.

### Examples 8-12, Comparative Examples 7-12, 19-24

For these examples, developers were prepared in the same manner as Example 7. However, the developer porosities of spherical ferrite particles and coating rates of carriers were changed as recorded in the FIGS. 1, 2, and 3.

Assessment

To assess printing performance before and after running, each of the aforementioned developers of examples and comparative examples was tested and compared before and after printing 30,000 sheets using a model FS3500 copier supplied by the Kyocera Corporation. The performance was estimated by three factors: ID (image density), FD (fogging density, namely the density of the part where image is fogged), and the quantity of electric charge of toner. If the level of the ID is 1.35 or more, no problem exists. If the FD is 0.007 or less, the image itself has no problem, but of course, an FD of 0 is optimal. If the quantity of the electric charge of the toner is about 13 (μC/g) or less, problems tend to appear, because if the quantity of electric charge of the toner becomes lower, the FD tends to be higher. If the FD is controlled and not high, a slightly high quantity of the electric charge in the toner does not cause a significant problem.

Each value for the above-mentioned carriers was measured by the method below. ID and FD:

Measured by a digital reflection densitometer produced by Tokyo Denshoku Co.

Quantity of Electric Charge of Toner:

Measured by Blow-Off toner charge measurement system produced by Toshiba Corporation.

Porosity of a Spherical Ferrite Particle:

Measured by measuring mercury intrusion value of a carrier particle by a porosimeter produced by Carlo Erba Instruments.

Resin-Coated Rate:

First, a carrier particle's image was taken with an SEM (Scanning Electron Microscope) and analyzed by an image analyzer. Then, each area of the resin-coated part of the smooth part, the resin-coated part of the porous part, the non-coated part of the smooth part, and the non-coated part of the porous part of the core particle was measured by the differences in contrasts of the images. Finally, the resin-coated rate was calculated by the ratio of the areas. The resin-coated rate was calculated by the steps of; (1) taking the image of a carrier particle using the SEM (Scanning Electron Microscope) and analyzing it with an image analyzer, (2) measuring each area of the resin-coated part of the smooth part, the resin-coated part of the porous part, the non-coated part of the smooth part, and the non-coated part of the porous part of the core particle, and (3) calculating the ratio of the areas.

As shown in FIGS. 1, 2, and 3, comparative examples 1 to 12 indicate that if a resin-coated rate of the smooth part is 20% or less and A×B/100 is less than 15, the quantity of the electric charge of the toner falls too low from the initial printing, resulting in a high fogging density of the image. In addition, comparative examples 13 to 24 indicate that if the resin-coated rate of the smooth part exceeds 20%, the resin coating peels after 30,000 prints causing a reduction in the quantity of the electric charge. As a result, fogging density tends to rise.

As shown in the detailed description above, by using the carrier of the present invention for use in electrophotography, peeling of a resin coating is suppressed. Thus, image properties of the initial printing will last long even as image forming continues. Therefore, the carrier can be used over an extended period realizing an object of present invention to lengthen the life of the carrier.

The terms of degree such as “substantially”, “about” and “approximately” as used herein mean a reasonable amount of deviation of the modified term such that the end result is not significantly changed. These terms should be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing description of the embodiments according to the present invention are provided for illustration only, and not for the purpose of limiting the invention as defined by the appended claims and their equivalents.

What is claimed is:

1. A carrier for electrophotography comprising:
a core particle; and
a resin coating applied to a surface of said core particle, said resin coating having
a porosity of the surface of said core particle being 40% or less,
a resin-coated rate of a porous part of said surface of said core particle being at least 37.5%, and
a resin-coated rate of a smooth part being 20% or less, such that the product of the percentage of said porosity and the percentage of said resin-coated rate results in a percentage of 15 or greater.

2. The carrier according to claim 1 wherein said core particle further comprises magnetic materials selected from the group consisting of sintered ferrite, magnetite, lithium, manganese, and iron powder.

3. The carrier according to claim 2 wherein said core particle has a particle diameter in the range of 20 μm to 200 μm.

4. The carrier according to claim 2 said core particle has a particle diameter in the range of 30 μm to 150 μm.

5. The carrier according to claim 1 wherein a resin supplied to said resin coating comprises one or more resins selected from the group consisting of acryl resins, (meth)acryl resins, styrene resins, styrene-acryl resins, styrene-(meth)acryl resins, olefin resins, polyester resins, unsaturated polyester resins, vinyl chloride resins, polyamide resins, polyurethane resins, epoxy resins, silicon resins, fluorine resins, phenol resins, xylene resins, and diallyl phthalate resins.

6. The carrier according to claim 1 wherein said resin coating includes additives to control properties of said resin coating.

7. The carrier according to claim 1 wherein said resin coating includes additives to control properties of said resin coating selected from the group consisting of silica, alumina, carbon black, and metal salts of fatty acids.
